(19) United States
(12) Patent Application Publication
(10) Pub. No.: US 2003/0030657 A1
(43) Pub. Date: Feb. 13, 2003

(54) Image distribution system, image distributing apparatus, image distribution method and program product for image distributing apparatus

(76) Inventor: Ogasawara Kenji, Toda-Shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/212,064

(22) Filed: Aug. 6, 2002

(30) Foreign Application Priority Data
Aug. 10, 2001 (JP) 2001-243837

(51) Int. Cl. G09G 5/00

(52) U.S. Cl. 345/700

(57) ABSTRACT

In an image distribution system, an image information reader reads image information regarding first image data. An image data output request sending unit sends an output request to a management server regarding the image data for which a selection input was received. An output permission/denial notification receiving unit receives a notification from the management server regarding whether output of the image data for which the selection input was received is permitted. An output destination unit determines where the output of the image data is permitted, whether or not the output destination for the image data is a specific image forming apparatus. When the output destination apparatus for the image data is a specific image forming apparatus, an image data decoder decodes image data for which selection input was received and obtains second image data. An image data sending unit sends the second image data to a specific image forming apparatus. An image data output permission/denial determining unit determines whether the output of the image data is to be permitted. An image data output permission/denial notification sending unit sends an output permission/denial notification to the image data distributing apparatus for the image data for which selection input was received.

This application is based on Patent Application No. 2001-243837 filed in Japan, the content of which is hereby incorporated by reference.

### BACKGROUND OF THE INVENTION

1. Field Of The Invention

The present invention relates to an image distribution system, and more particularly, to an image distribution system that distributes image data by storing it on a recording medium and permits one session of image formation through one session of image data output.

2. Description Of The Related Art

As image forming apparatuses such as printers have come to offer increasingly high image quality, the number of tones and the resolution of the image data handled by such apparatuses have improved and the amount of data has increased commensurately. When such large amounts of image data are to be provided to users, high-capacity storage media such as CD-ROMs, DVD-ROMs and hard disks, on which a large amount of image data can be recorded, have come to be used for distribution.

However, the problem has arisen that where such image data is stored in a high-capacity storage medium and distributed for money, once the image data is extracted from the storage medium, the output image data may be illegally copied and printed many times.

### SUMMARY

The present invention was created in view of the problem identified above, and an object thereof is to provide an image distribution system that can prevent improper use of image data due to copying by allowing printing of image data or other data distributed via a high-capacity storage medium that is sold for money only once when a fee is paid for the use thereof via electronic payment using deposit or credit.

The object of the present invention is attained by the following construction.

An image distribution system comprising an image data distributing apparatus, a management server and a specific image forming apparatus that are interconnected such that they can communicate with one another, wherein such image data distributing apparatus has an image information reader that reads, from a computer-readable recording medium on which encoded first image data is stored, the image information regarding this first image data; an image information display that displays the image information; an image data selector that receives the input by which to select the image data to output; an image data output request sending unit that sends to the management server an output request regarding the image data for which selection input was received; an image data output permission/denial notification receiving unit that receives a notification from the management server regarding whether or not output of the image data for which selection input was received is permitted; an output destination apparatus determining unit that determines, where the output of the image data for which selection input was received is permitted, whether or not the output destination apparatus for the image data is the specific image forming apparatus; an image data decoder that, where the output destination apparatus for the image data is the specific image forming apparatus, decodes from among the first image data the image data for which selection input was received and obtains second image data; and an image data sending unit that sends the second image data to the specific image forming apparatus, and wherein such management server has an image data output request receiving unit that receives the output request from the image data distributing apparatus regarding the image data for which selection input was received; an image data output permission/denial determining unit that determines whether or not the output of the image data for which selection input was received is to be permitted; and an image data output permission/denial notification sending unit that sends to the image data distributing apparatus an output permission/denial notification for the image data for which selection input was received.

The image data distributing apparatus further has an authentication code input unit that receives input of an authentication code that is obtained by encoding a first PIN code; a first authentication code sending unit that sends the authentication code to the management server; a first PIN code receiving unit that receives the first PIN code from the management server; a second authentication code sending unit that sends the authentication code to the image data output destination apparatus; and a second PIN code receiving unit that receives the second PIN code from the image data output destination apparatus. The management server further has a first authentication code receiving unit that receives the authentication code from the image data distributing apparatus; a user authentication unit that performs user authentication based on the authentication code; a first authentication code decoder that, where the user is verified during the user authentication process, decodes the authentication code and obtains the first PIN code; and a first PIN code sending unit that sends the first PIN code to the image data distributing apparatus. The specific image forming apparatus has a second authentication code receiving unit that receives the authentication code from the image data distributing apparatus; a second authentication code decoder that decodes the authentication code and obtains the first PIN code; and a second PIN code sending unit that sends the first PIN code to the image data distributing apparatus, wherein the output destination apparatus determining unit of such image data distributing apparatus determines whether or not the image data output destination apparatus is the specific image forming apparatus based on whether or not the first PIN code and the second PIN code match each other.

The specific image forming apparatus further has a first image formation result sending unit that sends to the image data distributing apparatus the result of the image formation regarding the second image data, the image data distributing apparatus further has a first image formation result receiving unit that receives the image formation result from the specific image forming apparatus, and a second image formation result sending unit that sends the image formation result to the management server, the management server further has a second image formation result receiving unit that receives the image formation result from the image data distributing apparatus, as well as an authentication code issuing unit that, where the specific image forming apparatus normally performed image formation regarding the second image data, issues to the user of the authentication code a new authentication code that is to replace the existing authentication code.

These and other objects, advantages and features of the invention will become apparent from the following description thereof taken in conjunction with the accompanying drawings which illustrate specific embodiments of the invention.

### BRIEF DESCRIPTION OF THE DRAWINGS

In the following description, like parts are designated by like reference numbers throughout the several drawings.

FIG. 1 is a block diagram showing the entire construction of the image distribution system of one embodiment of the present invention.

FIG. 2 is a block diagram showing the construction of the personal computer 1 of this embodiment.

FIG. 3 is a block diagram showing the construction of the management server 2 of this embodiment.

FIG. 4 is a block diagram showing one example of the construction of the printer 3 of this embodiment.

FIGS. 5, 6 and 7 are flow charts showing the sequence of the image distribution process performed by the personal computer 1 of this embodiment.

FIG. 8 is a drawing showing one example of the management table that is saved by the management server 2 in the hard disk 204 of this embodiment.

FIGS. 9 and 10 are flow charts showing the sequence of the image distribution process performed by the management server 2 of this embodiment.

FIG. 11 is a flow chart showing the sequence of the image distribution process performed by the printer 3 of this embodiment.

### DESCRIPTION OF THE PREFERRED EMBODIMENTS

An embodiment of the present invention is described in detail below with reference to the drawings.

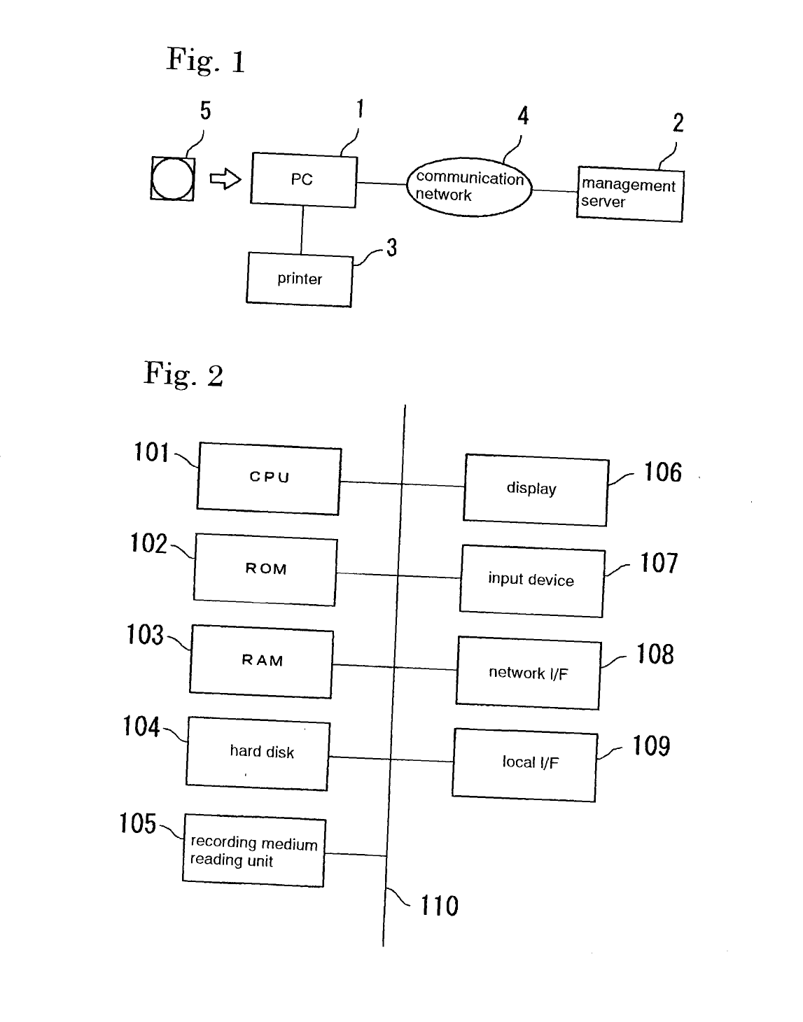

FIG. 1 is a block diagram showing the entire construction of the image distribution system of one embodiment of the present invention. The image distribution system of this embodiment includes a personal computer 1, which functions as an image data distributing apparatus, a management server 2, and a printer 3, which functions as an image forming apparatus, and the personal computer 1 and the management server 2 are connected via a communication network 4 while the personal computer 1 and the printer 3 are interconnected via a local interface such that they can communicate with one another. Furthermore, in the image distribution system of this embodiment, a recording medium 5 is used via user installation on the personal computer 1. The type and number of apparatuses connected to the communication network are not limited to the example shown in FIG. 1.

The construction of each apparatus described above will be described below, but members of the different apparatuses that have similar functions are described only once when they appear in the description for the first time, and such description will not be provided again in order to avoid repetition.

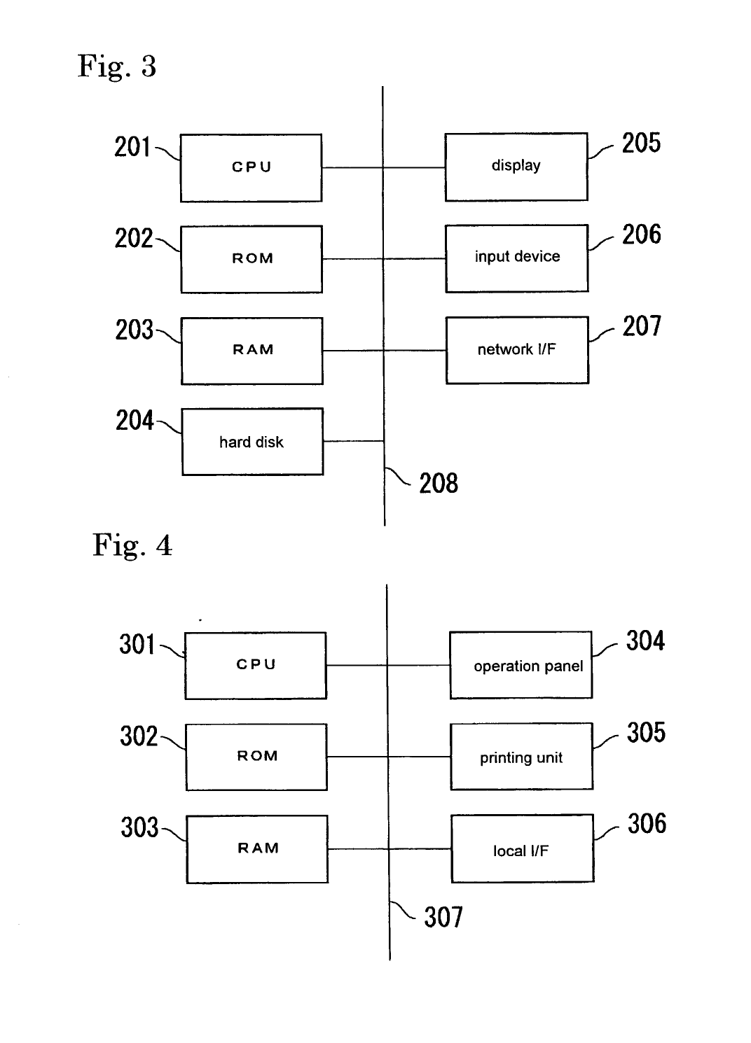

FIG. 2 is a block diagram showing one example of the construction of the personal computer 1 of this embodiment. With reference to FIG. 2, the personal computer 1 has a CPU 101, a ROM 102, a RAM 103, a hard disk 104, a recording medium reading unit 105, a display 106, an input device 107, a network interface 108, a local interface 109 and a bus 110.

The CPU 101 executes various control and computation operations. The ROM 102 stores various programs, the RAM 103 stores data temporarily as a work area, and the hard disk 104 stores various programs and data. The recording medium reading unit 105 comprises a drive or an interface corresponding to the recording medium 5, and incorporates various programs and data recorded on the recording medium 5 by reading the recording medium 5 that has been installed therein. The display 106 performs various display operations. The input device 107 comprises a keyboard and/or a mouse, and is used to perform various input operations. The network interface 108 is an interface by which to connect to the network and to communicate with other apparatuses on the network, and any of such standards as Ethernet (registered trademark), token-ring or FDDI is used. The local interface 109 is an interface by which to communicate with another apparatus such as a printer without the use of a network, and standards such as RS-232C, USB, IEEE1394, SCSI, IEEE1284, Bluetooth, IEEE802.11, HomeRF or IrDA may be used. In this embodiment, the personal computer 1 performs prescribed operations as described below, and the program that controls these operations is stored in the ROM 102 or on the hard disk 104.

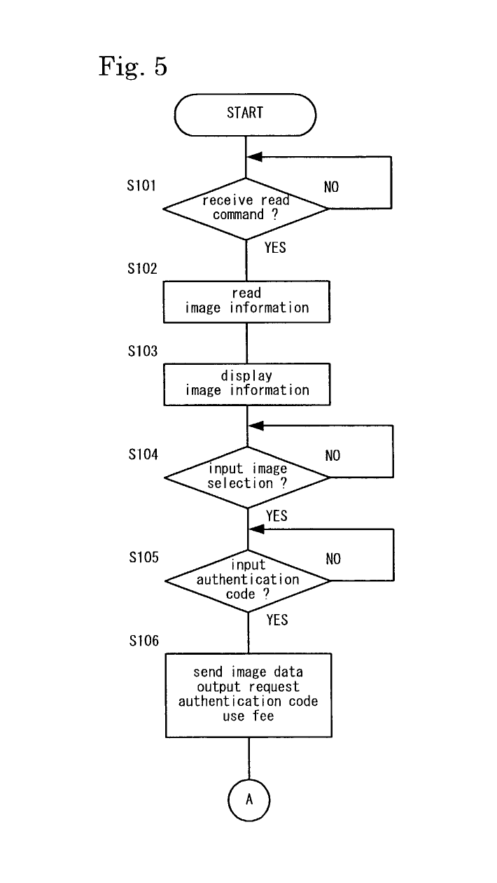

FIG. 3 is a block diagram showing one example of the construction of the management server 2 of this embodiment. With reference to FIG. 3, the management server 2 has a CPU 201, a ROM 202, a RAM 203, a hard disk 204, a display 205, an input device 206, a network interface 207 and a bus 208. As described below, where the management server 2 performs encoding of image data or storage thereof on the recording medium 5, it also has a recording medium writing unit that is compatible with the recording medium 5. In this embodiment, the management server 2 performs prescribed operations as described below, and the program that controls these operations is stored in the ROM 202 or on the hard disk 204.

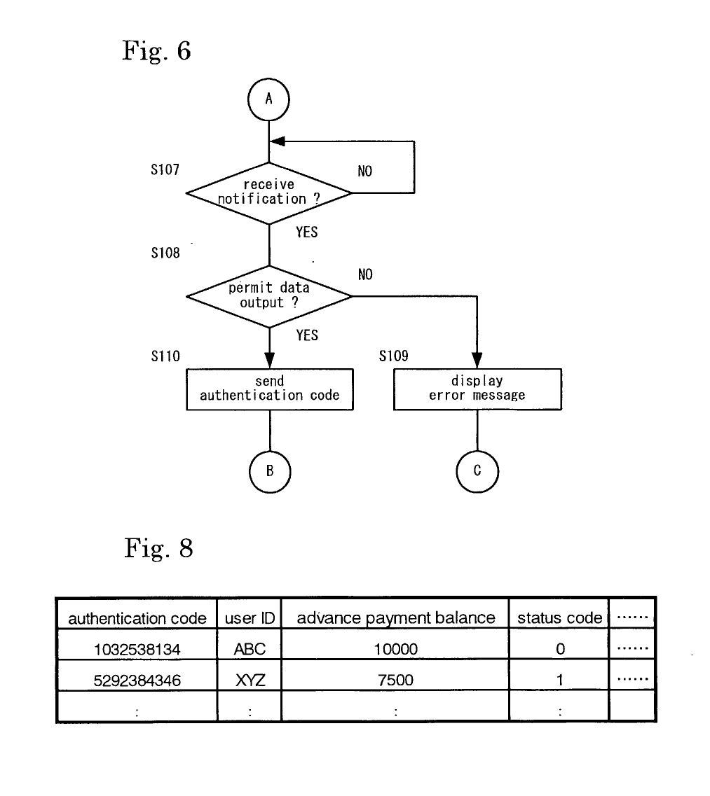

FIG. 4 is a block diagram showing one example of the construction of the printer 3 of this embodiment. With reference to FIG. 4, the printer 3 has a CPU 301, a ROM 302, a RAM 303, an operation panel unit 304, a printing unit 305, a local interface 306 and a bus 307. The operation panel unit 304 comprises a touch panel, fixed keys outside the touch panel, display lamps and the like, and is used in order to perform various input and display operations. The printing unit 305 performs printing based on printing jobs. In this embodiment, the printer 3 performs prescribed operations described below, and the program that controls these operations is stored in the ROM 302.

The communication network 4 includes a public network such as a telephone network, a mobile communication network, an ISDN or a packet exchange network, as well as a computer network such as a LAN, a WAN and/or the Internet.

The recording medium 5 is a computer-readable recording medium, and is not limited in any particular way in terms of the type thereof, and may comprise an optical recording medium, a magneto-optical recording medium, a magnetic recording medium, a removable hard disk, a flash memory or another type of recording medium. The recording medium 5 may also be a data supply server that is connected to the network.

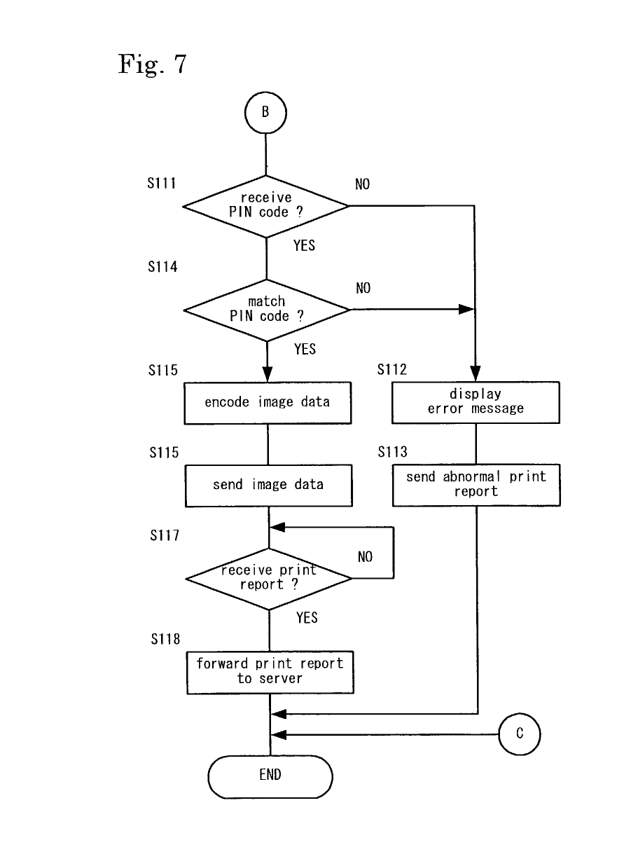

An outline of the operations of the image distribution system of this embodiment will now be described. FIGS. 5 through 7 are flow charts showing the sequence of the image distribution process performed by the personal computer 1 of this embodiment. With reference to FIG. 5, the personal computer 1 stands by until a command to read the recording medium is input (NO in S101). The user inserts the recording medium 5 into the recording medium reading unit 105 of the personal computer 1, and inputs via the input device 107 a command to read the recording medium.

Here, the recording medium 5 is distributed to the user by an image distribution service provider that uses the image distribution system of this embodiment for money or free of charge, and has encoded image data stored thereon. The recording medium 5 may be a medium that stores encoded image data having a single resolution per image or a medium that stores encoded image data having multiple different resolutions per image. In the latter case, multiple fees corresponding to each resolution may be established such that image data having the resolution corresponding to the paid fee is made available. Such encoding of image data and storage thereof on the recording medium 5 may be performed by the image data encoding unit and the recording medium writing unit incorporated in the management server 2, or may be performed by an image data encoding device associated with a dedicated personal computer.

When the input of a command to read the recording medium is received from the user (YES in S101), the personal computer 1 reads the image information regarding the encoded image data stored on the recording medium 5 and displays it on the display 106. Here, the image information comprises the titles, thumbnail image data, text data describing the image contents, and image information such as the resolution or charge information such as the use fee regarding the encoded image data stored in the recording medium 5. The personal computer 1 then stands by until selection of the image data to be output is input (NO in S104). The user inputs selection of the image data to be output using the input device 107 while referring to the image information displayed on the display 106. When receiving the input of the selection of the image data to be output from the user (YES in S104), the personal computer 1 stands by until an authentication code is input (NO in S105).

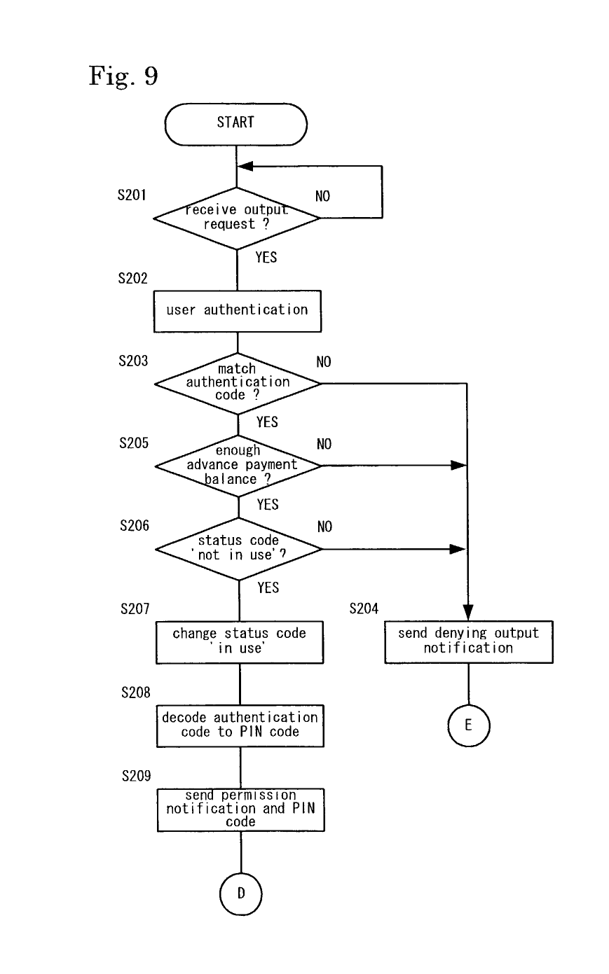

Here, an authentication code is a code that is used by the management server 2 to perform user authentication. It is issued to each registered user in advance and is managed by the management server 2. The user pays money to the image distribution service provider in advance and requests the issuance of an authentication code, and the image distribution service provider inputs necessary information into the management server 2, registers the user and issues an authentication code via the management server 2, and notifies the user of the issued authentication code. However, it is also acceptable if the user communicates with the management server 2 or other management servers using the personal computer 1 or another user terminal, performs the authentication code issuance process online using an electronic settlement system such as a credit card or electronic money, and receives an authentication code from the management server 2 online or via e-mail. In the image distribution system of this embodiment, an authentication code is created by encoding a PIN code generated as random numbers using a specific encoding algorithm. The issued authentication code is stored in the management table in the hard disk 204 of the management server 2. FIG. 8 shows one example of the management table saved on the hard disk 204 by the management server 2. In addition to the authentication code, such other information as the corresponding user ID, the advance payment balance and the status code are also recorded in the management table. The user ID is a code unique to each user that is used to identify users. The advance payment balance shows the balance of the advance payment that was made by the user in order to obtain the authentication code. Each time the image distribution service is used and image data is distributed, the use fee for the used image data is subtracted from this balance, and when a new advance payment is made by the user, the paid amount is added to the balance. It is also acceptable if use points that are equivalent to the advance payment balance or points or codes that express the number of times the service has been used, the period during which the service is available, etc. is used instead of the advance payment balance. The status code is a code that indicates whether or not the authentication code is currently being used by the image distribution system.

When the input of an authentication code is received from the user (YES in S105), the personal computer 1 sends to the management server 2 via the network interface 108 and the communication network 4 the output request for the image data for which selection input was received in step S104, together with the use fee for the image data and the obtained authentication code.

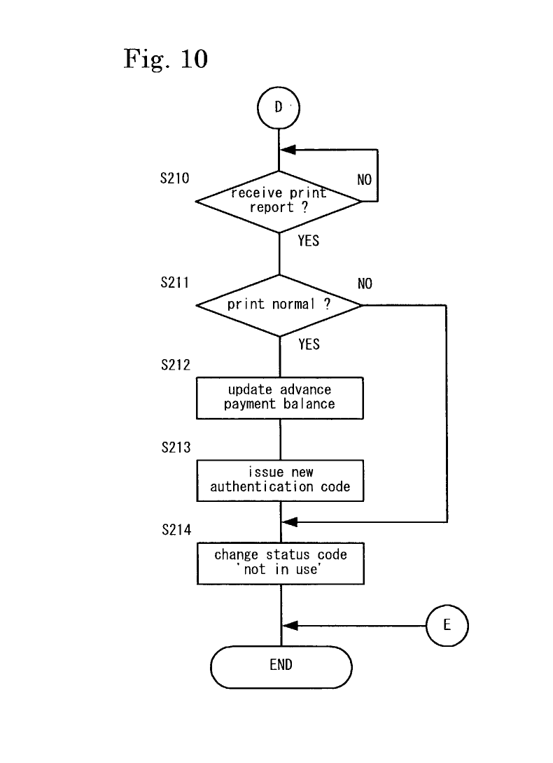

FIGS. 9 and 10 are flow charts showing the sequence of the image distribution process performed by the management server 2 of this embodiment. With reference to FIG. 9, the management server 2 stands by until an image data output request is received from the personal computer 1 (NO in S201), and when an image data output request is received from the personal computer 1 via the communication network 4 and the network interface 207 (YES in S201), it reads out the management table stored on the hard disk 204, and performs user authentication by checking the authentication code received together with the image data output request against all of the authentication codes in the management table (S202). Where none of the authentication codes in the management table matches the received authentication code (NO in S203), the management server 2 sends to the personal computer 1 via the network interface 207 and the communication network 4 a notification denying image data output (S204). Consequently, improper image data output by persons other than authorized users to whom an authentication code has been issued can be prevented.

On the other hand, where the received authentication code matches one of the authentication codes in the management table (YES in S203), it is verified whether or not the advance payment balance regarding the authentication code stored in the management table equals or exceeds the use fee for the image data that was simultaneously received with the image data output request (S205). Where the advance payment balance is less than the use fee (NO in S205), an image data output denial notification is sent to the personal computer 1 (S204). Consequently, improper output of image data without payment of the image data use fee can be prevented. Where the advance payment balance equals or exceeds the use fee (YES in S205), it is verified whether the status code regarding the authentication code indicates ‘in use’ or ‘not in use’, and where the status code indicates ‘in use’ (NO in S206), an image data output denial notification is sent to the personal computer 1 (S204). Consequently, improper output of image data based on duplicate access by a third party can be prevented. Where the status code indicates ‘not in use’ (YES in S206), the status code is changed to indicate ‘in use’ (S207), and the authentication code is decoded to obtain a PIN code (S208). An image data output permission notification is then sent to the personal computer 1 together with the PIN code, which was obtained as a result of the decoding, via the network interface 207 and the communication network 4 (S209).

At the same time, with reference to FIG. 6, the personal computer 1 stands by until an image data output permission/denial notification is received from the management server 2 (NO in S107), and when an image data output permission/denial notification is received from the management server 2 via the communication network 4 and the network interface 108 (YES in S107), where the notification indicates denial (NO in S108), an error message to that effect is displayed on the display 106 (S109), whereby the image distribution process is ended. Where image data output is permitted (YES in S108), the authentication code, the input of which was received in step S105, is sent via the local interface 109 to the printer 3, which is the destination for the image data output (S110).

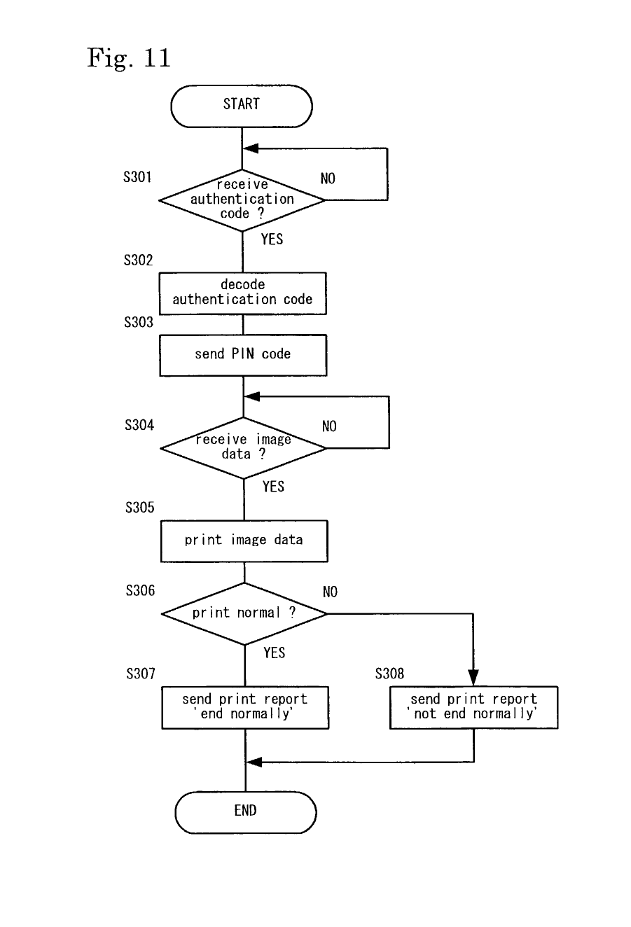

FIG. 11 is a flow chart showing the sequence of the image distribution process performed by the printer 3 of this embodiment. With reference to FIG. 11, the printer 3 stands by until an authentication code is received from the personal computer 1 (NO in S301), and when an authentication code is received from the personal computer 1 via the local interface 306 (YES in S301), it obtains a PIN code by decoding the received authentication code (S302), and sends the thus obtained PIN code to the personal computer 1 via the local interface 306 (S303).

With reference to FIG. 7, where a PIN code is not received from the printer 3 within a prescribed period of time (NO in S111), the personal computer 1 displays on the display 106 an error message indicating that the image data output destination is not an authorized printer (S112) and sends to the management server 2 a print result report indicating that printing did not end normally (S113), whereupon the image distribution process is ended. On the other hand, where a PIN code is received from the printer 3 within the prescribed period of time (YES in S11), it is verified whether or not the received PIN code matches the PIN code received in step S107 together with the image data output permission notification. Where they do not match (NO in S114), the personal computer 1 displays an error message indicating that the image data output destination is not an authorized printer (S112) and sends a print result report to the effect that printing did not end normally to the management server 2 (S113), whereupon the image distribution process is ended. Consequently, output of image data to an apparatus that is not an authorized printer can be prevented, thereby preventing improper use of the output image data.

Where the PIN codes match (YES in S114), the image data for which selection input was received in step S104 is decoded from among the encoded image data stored in the recording medium 5 (S115), and the image data obtained as a result of decoding is sent to the printer 3 via the local interface 109 (S116).

With reference to FIG. 11, the printer 3 stands by until image data is received from the personal computer 1 (NO in S304), and when image data is received from the personal computer 1 via the local interface 306 (YES in S304), the printer 3 prints out the received image data (S305). Where the printing ended normally (YES in S306), a printing result report indicating that printing ended normally is sent to the personal computer 1 via the local interface 306 (S307), whereupon the image data printing process is ended. Where the printing did not end normally (NO in S306), a print result report indicating that printing did not end normally is sent to the personal computer 1 (S308), whereupon the image data printing process is ended.

At the same time, with reference to FIG. 7, the printer 1 stands by until an image data print result report is received from the printer 3 (NO in S117), and when an image data print result report is received from the printer 3 via the local interface 109 (YES in S117), it forwards the received image data print result report to the management server 2 via the network interface 108 and the communication network 4 (S118), whereupon the image data distribution process is ended.

With reference to FIG. 10, the management server 2 stands by until an image data print result report is received from the personal computer 1 (NO in S210), and when an image data print result report is received from the printer 3 via the communication network 4 and the network interface 207 (YES in S210), where the print result report indicates that printing ended normally (YES in S211), the management server 2 subtracts the use fee for the output image from the advance payment balance for the user, which is monitored via the management table, updates the advance payment balance and registers the transaction in the management table (S212). It then generates a new PIN code using random numbers, encodes it to issue a new authentication code, and registers it in the management table as the user's new authentication code (S213). Consequently, the authentication code is changed each time image data is output, so that improper image data output based on an improperly obtained authentication code can be prevented. The status code for the user is then changed to indicate ‘not in use’ (S214), the management table is saved onto the hard disk 204, and the user authentication process is ended. The new authentication code registered in the management table is conveyed to the user by the image distribution service provider, or is sent online or via e-mail by the management server 2 to the personal computer 1 or other user terminal. On the other hand, where a print result report indicating that printing did not end properly is received (NO in S211), the status code for the user is changed to indicate ‘not in use’ without any further processing (S214), the management table is saved onto the hard disk 204, and the user authentication process is ended.

In the embodiment described above, the determination regarding whether or not the image data output destination is an authorized printer was made based on the determination regarding whether the printer can properly decode the PIN code encoded using a specific encoding algorithm, i.e., whether or not the printer has a circuit for the decoding algorithm that corresponds to a specific encoding algorithm, but the method to determine whether or not the image data output destination is an authorized printer is not limited to this implementation. For example, a method in which the determination is made based on an ID number unique to the apparatus, such as the printer's MAC address, or a method in which a serial number or the like is written in the printer's ROM such that this number is obtained and used for the determination may be used instead.

Furthermore, in the embodiment described above, the user makes an advance payment to the image distribution service provider in order to obtain an authentication code, but it is acceptable if no authentication code is issued in advance, and a user wishing to receive image data from the image distributing apparatus pays the use fee at that time through the electronic settlement system by inputting his credit card number or submitting his prepaid card, debit card, electronic money or the like for reading using a card reader and thereupon receives the image data.

Furthermore, the image distribution system of the present invention may be used not only for fee-based distribution of image data, but also for free distribution of image data, such as when output is permitted only once due to security reasons.

The management apparatus and the image data distributing apparatus may be the same apparatus.

In the embodiment described above, the image distribution system of the present invention was described using a personal computer and a printer as the image data distributing apparatus and the image forming apparatus, respectively, but the present invention is not limited to this implementation. The image data distributing apparatus may comprise a stand-alone computer such as a personal computer or a workstation owned by the user, or a computer that works as a dedicated terminal for the management server. In addition, the image forming apparatus may comprise a printer or multi-function peripheral having a printing capability, such as a digital copying machine or a facsimile machine, or a display apparatus such as a CRT display, a liquid crystal display or a projector.

In addition to the embodiment described above, the image distribution system of the present invention may have a construction in which the image distribution process sequences performed by the image data distributing apparatus and the management server are executed by a single image distributing apparatus such as a personal computer, or in which the image distribution process sequences performed by the image data distributing apparatus and the image forming apparatus are executed by a single image distributing apparatus such as a multi-function peripheral, including a digital copying machine or a facsimile machine.

The various means that comprise each apparatus in this image distribution system as well as the image distribution method of the present invention may be implemented using dedicated hardware circuits to execute each processing routine described above or by CPUs executing a prescribed program describing the various processing routines. Where the present invention is implemented using the latter means, the prescribed program that operates each apparatus may be provided on a computer-readable recording medium such as a flexible disk or a CD-ROM or downloaded online via a network such as the Internet. In this case, the program recorded on a computer-readable recording medium is usually forwarded to the ROM, hard disk or the like and stored therein. In addition, the program may be provided as stand-alone application software, for example, or may be incorporated in the software of each apparatus as one function of the apparatus. A program product includes the program itself as well as the recording medium on which the program is recorded.

Although preferred embodiment of the invention have been described in the foregoing detailed description and illustrated in the accompanying drawings, it will be understood that the invention is not limited to the embodiment disclosed, but is capable of numerous rearrangements, modifications and substitutions of parts and elements without departing from the spirit of the invention. Accordingly, the present invention is intended to encompass such rearrangements, modification and substitutions of parts and elements as fall within the spirit and scope of the invention.

What is claimed is:

1. An image distribution system comprising:
a data distributing apparatus;
a management server; and
an image forming apparatus;
wherein the data distributing apparatus has an image information reader that reads, from a computer-readable medium on which encoded first image data is stored, the image information regarding this first image data; a display that displays the image information; an image data selector that receives the input by which to select the image data to output; an image data output request sending unit that sends to the management server an output request regarding the image data for which selection input was received; an image data output permission/denial notification receiving unit that receives a notification from the management server regarding whether or not output of the image data for which selection input was received is permitted; an output destination apparatus determining unit that determines, where the output of the image data for which selection input was received is permitted, whether or not the output destination apparatus for the image data is the specific image forming apparatus; an image data decoder that, where the output destination apparatus for the image data is the specific image forming apparatus, decodes from among the first image data the image data for which selection input was received and obtains second image data; and an image data sending unit that sends the second image data to the specific image forming apparatus.

2. The system according to claim 1, wherein said management server has an image data output request receiving unit that receives the output request from the image data distributing apparatus regarding the image data for which selection input was received; an image data output permission/denial determining unit that determines whether or not the output of the image data for which selection input was received is to be permitted; and an image data output permission/denial notification sending unit that sends to the image data distributing apparatus an output permission/denial notification for the image data for which selection input was received.

3. The system according to claim 2, wherein said image data distributing apparatus further has an authentication code input unit that receives input of an authentication code that is obtained by encoding a first PIN code; a first authentication code sending unit that sends the authentication code to the management server; a first PIN code receiving unit that receives the first PIN code from the management server; a second authentication code sending unit that sends the authentication code to the image data output destination apparatus; and a second PIN code receiving unit that receives the second PIN code from the image data output destination apparatus and said management server further has a first authentication code receiving unit that receives the authentication code from the image data distributing apparatus; a user authentication unit that performs user authentication based on the authentication code; a first authentication code decoder that, where the user is verified during the user authentication process, decodes the authentication code and obtains the first PIN code; and a first PIN code sending unit that sends the first PIN code to the image data distributing apparatus and said specific image forming apparatus has a second authentication code receiving unit that receives the authentication code from the image data distributing apparatus; a second authentication code decoder that decodes the authentication code and obtains the first PIN code; and a second PIN code sending unit that sends the first PIN code to the image data distributing apparatus, wherein the output destination apparatus determining unit of such image data distributing apparatus determines whether or not the image data output destination apparatus is the specific image forming apparatus based on whether or not the first PIN code and the second PIN code match each other.

4. The system according to claim 1, wherein said image forming apparatus further has a first image formation result sending unit that sends to the image data distributing apparatus the result of the image formation regarding the second image data, the image data distributing apparatus further has a first image formation result receiving unit that receives the image formation result from the specific image forming apparatus, and a second image formation result sending unit that sends the image formation result to the management server, the management server further has a second image formation result receiving unit that receives the image formation result from the image data distributing apparatus, as well as an authentication code issuing unit that, where the specific image forming apparatus normally performed image formation regarding the second image data, issues to the user of the authentication code a new authentication code that is to replace the existing authentication code.

5. An image distribution apparatus comprising:
an image information reader that reads, from a computer-readable medium on which encoded first image data is stored, the image information regarding this first image data;
a display that displays the image information;
an image data selector that receives the input by which to select the image data to output;
an image data output request sending unit that sends to a management server an output request regarding the image data for which selection input was received;
an image data output permission/denial notification receiving unit that receives a notification from the management server regarding whether or not output of the image data for which selection input was received is permitted;
an output destination apparatus determining unit that determines, where the output of the image data for which selection input was received is permitted, whether or not the output destination apparatus for the image data is the specific image forming apparatus;
an image data decoder that, where the output destination apparatus for the image data is the specific image forming apparatus, decodes from among the first image data the image data for which selection input was received and obtains second image data; and
an image data sending unit that sends the second image data to the specific image forming apparatus.

6. The apparatus according to claim 5, further comprising:
authentication code input means that receives input of an authentication code obtained by encoding a first PIN code;
first authentication code sending means that sends the authentication code to the management server;
first PIN code receiving means that receives the first PIN code from the management server;
second authentication code sending means that sends the authentication code to the image data output destination apparatus; and
second PIN code receiving means that receives the second PIN code from the image data output destination apparatus,
wherein the determining means of the output destination apparatus determines whether or not the image data output destination apparatus is the specific image forming apparatus, based on whether or not the first PIN code and the second PIN code match.

7. The apparatus according to claim 5, further comprising:
first image formation result receiving means that receives the result of image formation regarding the second image data from the specific image forming apparatus; and
second image formation result sending means that sends the image formation result to the management server.

8. An image distribution system management server comprising:
image data output request receiving means that receives an image data output request from the image data distributing apparatus;
image data output permission/denial determining means that determines whether the image data output should be permitted or denied;
image data output permission/denial notification sending means that sends to the image data distributing apparatus a notification permitting or denying the image data output;
authentication code receiving means that receives an authentication code obtained by encoding a PIN code from the image data distributing apparatus;
user authenticating means that performs user authentication based on the authentication code;
authentication code decoding means that obtains the PIN code by decoding the authentication code when the user is authenticated during user authentication; and
a PIN code sending apparatus that sends the PIN code to the image data distributing apparatus.

9. The management server according to claim 8, further comprising:
image formation result receiving means that receives from the image data distributing apparatus the result of image formation regarding the image data; and
authentication code issuing means that issues a new authentication code for the user that will replace the existing authentication code when image formation regarding the image data was normally performed.

10. An image forming apparatus comprising:
an authentication code receiver that receives from the image data distributing apparatus an authentication code obtained by encoding a PIN code;
an authentication code decoder that obtains the PIN code by decoding the authentication code; and
PIN code sending means that sends the PIN code to an image data distributing apparatus.

11. The image forming apparatus according to claim 10, wherein said apparatus further comprising:
first image formation result sending means that sends the result of image formation regarding the image data to the image data distributing apparatus.

12. A program product for allowing a management server to perform management process, said management process comprising the steps of:
receiving an image data output request from an image data distributing apparatus;
determining whether or not image data output should be permitted or denied;
sending to the image data distributing apparatus a notification permitting or denying image data output;
receiving from the image data distributing apparatus an authentication code obtained by encoding a PIN code;
performing user authentication based on the authentication code;
obtaining the PIN code by decoding the authentication code when the user was authenticated during user authentication; and
sending the PIN code to the image data distributing apparatus.

13. The program product according to claim 12, wherein said management process further comprising the steps of:
receiving from the image data distributing apparatus the result of image formation regarding the image data; and
issuing, when image formation regarding the image data was normally performed, a new authentication code for the user that will replace the existing authentication code.

14. An image distribution program product for allowing an image data distributing apparatus to perform distribution process, said distribution process comprising the steps of:
receiving input of an authentication code obtained by encoding a first PIN code;
sending the authentication code to a management server;
receiving the first PIN code from the management server;
sending the authentication code to an image data output destination apparatus; and
receiving a second PIN code from the image data output destination apparatus, wherein determination regarding whether or not the image data output destination apparatus is the specific image forming apparatus is made by determining whether or not the first PIN code and the second PIN code match.

15. The program product according to claim 14, wherein said distribution process further comprising the steps of:
receiving from the specific image forming apparatus the result of image formation regarding the second image data; and
sending the image formation result to the management server.

16. A program product for allowing an image forming apparatus to perform distribution process, said distribution process comprising the steps of:
receiving an authentication code obtained by encoding a PIN code from an image data distributing apparatus;
obtaining the PIN code by decoding the authentication code; and
sending the PIN code to an image data distributing apparatus.
